(19) United States
(12) Patent Application Publication
(10) Pub. No.: US 2021/0310159 A1
(43) Pub. Date: Oct. 7, 2021

(54) POLYMERIC YARN, COMPOSITION AND METHOD

(71) Applicants: Abhishek Rajesh Mandawewala, Mumbai (IN); Khushboo Abhishek Mandawewala, Mumbai (IN)

(72) Inventors: Abhishek Rajesh Mandawewala, Mumbai (IN); Khushboo Abhishek Mandawewala, Mumbai (IN)

(21) Appl. No.: 17/148,618

(22) Filed: Jan. 14, 2021

Related U.S. Application Data
(63) Continuation-in-part of application No. 15/424,851, filed on Feb. 5, 2017.

(30) Foreign Application Priority Data
Aug. 13, 2020 (IN) 202021034915

(51) Int. Cl. D02G 3/44; C08L 67/02; C08L 77/02; C08L 23/12; C08J 3/22; D02G 3/04; A01N 25/10; A01N 65/26; A01N 65/48

(52) U.S. Cl. CPC D02G 3/449; C08L 67/02; C08L 77/02; C08L 23/12; C08J 3/226; C08L 2205/025; A01N 25/10; A01N 65/26; A01N 65/48; C08L 2310/00; C08L 2203/12; D02G 3/04

(57) ABSTRACT

A polymeric yarn composition having antimicrobial and/or antibacterial properties includes: (i) an herbal masterbatch in a range of 0.01% w/w to 10% w/w, and (ii) a base polymer in a range of 90% w/w to 99.99% w/w. The base polymer may include one of polybutylene terephthalate (PBT) or polyethylene terephthalate (PET), or polyamides, or polypropylene. Further, the herbal masterbatch may include: (a) an herbal component includes Neem or Turmeric or combination thereof in a range of 1% w/w to 75% w/w, and (b) a carrier polymer in a range of 25% w/w to 99% w/w. The carrier polymer may same as the base polymer and may include one of: PBT, PET, polyamides or polypropylene. To make a polymeric yarn, the herbal masterbatch and the base polymer may be melted and extruded together to obtain the polymeric yarn having the herbal component in a range of 0.01% to 10% in weight of the polymeric yarn.

### FIELD OF THE DISCLOSURE

The present disclosure relates to textile industries, and, more particularly, to a polymeric yarn and composition having antimicrobial and/or antibacterial properties.

### BACKGROUND OF THE DISCLOSURE

Textile industry has conventionally been using both natural and synthetic fibers for manufacture of various products. Each having their own advantages and shortcomings related to strength, comfort, softness, longevity and the like. With ever-increasing demand to provide enhanced quality fibers manufacturers apart from enhancing traditional properties, have started incorporating more functional elements to fibers to provide better comfort, freshness, and hygiene to users. In pursuit of meeting demands of modern hygienic lifestyle, there have been several attempts to add a variety of chemical agents to fabrics providing them with antimicrobial and antibacterial properties. These agents are normally applied on the surface to impart antimicrobial and antibacterial properties to the fabrics during finishing stage.

However, items made with such fabrics are unable to retain antimicrobial and antibacterial properties for long and as the compounds are washed-off during washings or ultra-violet exposure. A significant reason that these fibers are not able to provide long-term antimicrobial and antibacterial effects lies on the fact that these components are added to the fiber during the fabric finishing stage through the use of various finishing chemicals. Moreover, there is always a concern regarding use of such chemical agents and their potential after-effects on human body.

Therefore, there exists a need for innovation in relation to this technology to overcome the shortcomings prevalent in the market.

### SUMMARY OF THE DISCLOSURE

In view of the foregoing disadvantages inherent in the prior art, the general purpose of the present disclosure is to provide a polymeric yarn and composition having antimicrobial and/or antibacterial properties, to include all advantages of the prior art, and to overcome the drawbacks inherent in the prior art.

Therefore, an object of the present disclosure is to provide a polymeric yarn composition or polymeric yarn made from such composition, and method of making such polymeric yarn that incorporates antimicrobial and/or antibacterial properties.

Another object of the present disclosure is to provide a polymeric yarn composition or polymeric yarn having an herbal masterbatch with herbal component therein that incorporates antimicrobial and/or antibacterial properties.

Another object of the present disclosure is to provide a method for preparing a polymeric yarn having an herbal masterbatch with herbal component therein that incorporates antimicrobial and/or antibacterial properties.

In light of the above objects, in one aspect, a polymeric yarn composition having antimicrobial and/or antibacterial properties for textile materials is provided. The polymeric yarn composition includes: (i) an herbal masterbatch in a range of 0.01% w/w to 10% w/w, and (ii) a base polymer in a range of 90% w/w to 99.99% w/w. The base polymer may include one of polybutylene terephthalate (PBT) or polyethylene terephthalate (PET), or polyamides, or polypropylene. Further, the herbal masterbatch, in one embodiment, may include: (a) an herbal component that may include Neem or Turmeric or combination thereof in a range of 1% w/w to 75% w/w, and (b) a carrier polymer in a range of 25% w/w to 99% w/w. The carrier polymer may same as the base polymer and may include at least one of: polybutylene terephthalate (PBT), polyethylene terephthalate (PET), or polyamides, polypropylene. In one embodiment, in order to make a polymeric yarn, the herbal masterbatch and the base polymer may be melted and extruded together at a temperature in a range of 175° C. to 300° C. to obtain the polymeric yarn having the herbal component in a range of 0.01% to 10% in weight of the polymeric yarn.

In light of the above objects, in one another aspect, a method for preparing a polymeric yarn having antimicrobial and/or antibacterial properties for textile materials is provided. The method may include: preparing an herbal masterbatch, wherein the herbal masterbatch includes: (i) an herbal component having Neem or Turmeric or combination thereof in a range of 1% w/w to 75% w/w, and a carrier polymer having at least one of polybutylene terephthalate (PBT), or poly(ethylene terephthalate) (PET), polyamides, or polypropylene, wherein the carrier polymer is in a range of 25% w/w to 99% w/w; (ii) mixing the herbal masterbatch in a range of 0.01% w/w to 10% w/w, and a base polymer in a range of 90% w/w to 99.99% w/w, wherein the base polymer comprises one of polybutylene terephthalate (PBT) or polyethylene terephthalate (PET), or polyamides, or polypropylene; and (iii) melting and extruding the mixture of the herbal masterbatch and the base polymer at a temperature in a range of 175° C. to 300° C. to obtain the polymeric yarn having the herbal component in a range of 0.01% to 10% on weight of the polymeric yarn.

In one embodiment of the present disclosure, preparing the herbal masterbatch may include: (i) melting a mixture of the herbal component and the carrier polymer at a temperature in a range of 175° C. to 300° C. to obtain a melted homogeneous mixture of the herbal component and the carrier polymer, wherein the mixture of the herbal component and the carrier polymer comprises: Neem or Turmeric or combination thereof in the range of 1% w/w to 75% w/w, and the carrier polymer having at least one of the polybutylene terephthalate (PBT), or the poly(ethylene terephthalate) (PET), or the polyamides, or polypropylene, wherein the carrier polymer is in the range of 25% w/w to 99% w/w; and (ii) solidifying the melted homogeneous mixture herbal component and the carrier polymer underwater at a temperature in a range of 4° C. to 30° C. to obtain the herbal masterbatch.

In light of the above objects, in one another aspect, an herbal masterbatch composition for making a polymeric yarn for textile materials is provided. The herbal masterbatch includes an herbal component and a carrier polymer. The herbal component may include Neem or Turmeric or combination thereof in a range of 1% w/w to 75% w/w. Further, the carrier polymer may include at least one of: polybutylene terephthalate (PBT), polyethylene terephthalate (PET), or polyamides, or polypropylene. The carrier polymer may be in a range of 25% w/w to 99% w/w. In one embodiment of the present disclosure, the Neem or Turmeric or combination thereof may be used in a powder form having size of the powder is in a range of 0.001 microns to 25 microns to make the polymeric yarn. In another embodiment, the Neem or Turmeric or combination thereof may be used in a liquid form to make the polymeric yarn.

In light of the above objects, in yet one another aspect, a polymeric yarn for making textile material is provided. The polymeric yarn may include an herbal component having Neem or Turmeric or combination thereof; and a base polymer having one of polybutylene terephthalate (PBT) or polyethylene terephthalate (PET), or polyamides, or polypropylene, wherein the herbal component in the polymeric yarn is in a range of 0.01% to 10% on the weight of the polymeric yarn.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawings, in which:

FIGS. 1A to 1C illustrate various kind of yarns having herbal content therein that exhibits antimicrobial and/or antibacterial properties for textile materials, in accordance with an exemplary embodiment of the present disclosure;

FIGS. 2A and 2B illustrate methods of making yarns of FIGS. 1A to 1C, in accordance with an exemplary embodiment of the present disclosure; and

FIG. 3 shown a sample of textile for test result, in accordance with an exemplary embodiment of the present disclosure.

Like reference numerals refer to like parts throughout the description of several views of the drawing.

### DETAILED DESCRIPTION OF THE DISCLOSURE

The exemplary embodiments described herein detail for illustrative purposes are subject to many variations in implementation. The present disclosure provides a polymeric yarn and composition having antimicrobial and/or antibacterial properties. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signify the presence of a component.

The term “% w/w” used herein means grams of solute dissolved in 100 grams of solution.

The present disclosure provides a polymeric yarn composition having antimicrobial and/or antibacterial properties for textile materials. In one embodiment of the present disclosure, the polymeric yarn composition may include an herbal masterbatch and a base polymer. In one example of the present disclosure, the polymeric yarn composition may include the herbal masterbatch in a range of 0.01% w/w to 10% w/w, and the base polymer may be in a range of 90% w/w to 99.99% w/w, which means that if 0.01% w/w of herbal masterbatch is used than 99.99 w/w of the base polymer may be used, and if 10% w/w of herbal masterbatch is used than 90% w/w of the base polymer may be used. In further example embodiment of the present disclosure, the polymeric yarn composition may include the herbal masterbatch in a preferable range of 0.1% w/w to 8% w/w, and the base polymer may be in a preferable range of 99.9 w/w % to 92% w/w, which means that if 0.1% w/w of herbal masterbatch is used than 98% w/w of the base polymer may be used, and if 8% w/w of herbal masterbatch is used than 92% w/w of the base polymer may be used. In yet another example embodiment of the present disclosure, the polymeric yarn composition may include the herbal masterbatch in a more preferable range of 2% w/w to 5% w/w, and the base polymer may be in a most preferable range of 98% w/w to 95% w/w, which means that if 2% w/w of herbal masterbatch is used than 98% w/w of the base polymer may be used, and if 5% w/w of herbal masterbatch is used than 95% w/w of the base polymer may be used.

The herbal masterbatch, in such embodiment of the polymeric yarn composition, may include the herbal component that may have Neem or Turmeric or combination thereof in a range of 1% to 75% w/w, preferably in a range of 10% w/w to 40% w/w; more preferably in a range of 20% w/w to 30% w/w, for example about 25% w/w or 30% w/w. Further, the herbal masterbatch, in such embodiment of the polymeric yarn composition, may include a carrier polymer in a range of 25% w/w to 99% w/w; preferably in a range of 90% w/w to 60% w/w; more preferably in a range of 80% w/w to 70% w/w, for example about 75% w/w or 70% w/w. In one embodiment of the present disclosure, the Neem or Turmeric or combination thereof may be used in a powder form having size of the powder is in a range of 0.001 microns to 25 microns to make the herbal masterbatch. In another embodiment, the Turmeric or combination thereof may be used in a liquid form to make the herbal masterbatch. Furthermore, the carrier polymer, in such herbal masterbatch, may be one of polybutylene terephthalate (PBT), polyethylene terephthalate (PET), polyamides or polypropylene. In one embodiment, a chemical extract of Neem or Turmeric or combination thereof may be used to make the herbal masterbatch. Such chemical extract that may be extracted from the Neem may include, but not limited to, nimbin, nimbanene, 6-desacetylnimbinene, nimbandiol, nimbolide, ascorbic acid, n-hexacosanol and amino acid, 7-desacetyl-7-benzoylazadiradione, 7-desacetyl-7-benzoylgedunin, 17-hydroxyazadiradione and nimbiol [3], [10], [12]. Further, the chemical extract that may be extracted from the turmeric may include, but not limited to, Curcuminoids or Curcumin and so forth. One or other chemical extract of Neem or turmeric may be used in combination or alone to obtain the effective result.

The base polymer, in such embodiment of the polymeric yarn composition, may include one of polybutylene terephthalate (PBT) or polyethylene terephthalate (PET), or polyamides, or polypropylene. In one embodiment of the present disclosure, the polyamides may generally include Polyamide 6 (PA6) or Polyamide 66 (PA66). In one preferred embodiment of the present disclosure, the base polymer and the carrier polymer may generally be of same polymer group in such polymeric yarn composition.

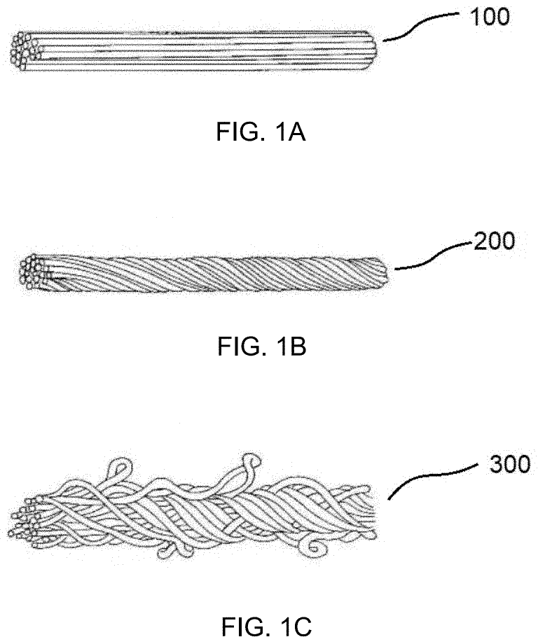

The polymeric yarn composition as described above may be utilized to manufacture a polymeric yarn 100 or a twisted continuous polymeric yarn 200 or a bulk continuous polymeric yarn 300 as shown in FIGS. 1A, 1B and 1C. Such yarns made from the polymeric yarn composition as described above exhibit antimicrobial and/or antibacterial properties.

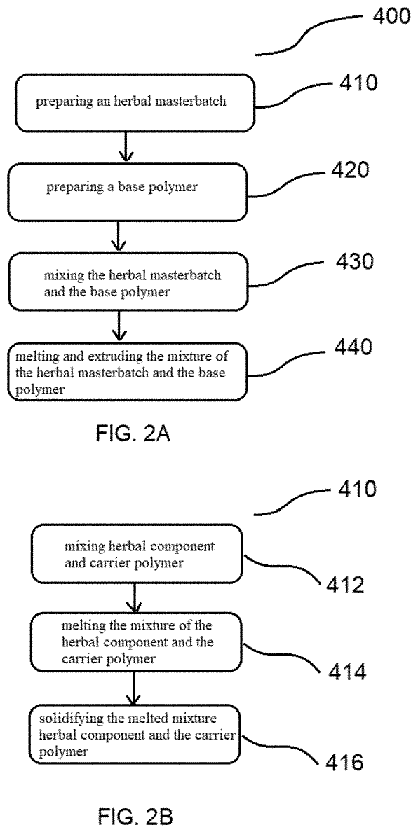

In one embodiment of the present disclosure, a block diagram of a method 400 for preparing such polymeric yarn 100 or the twisted continuous polymeric yarn 200 or the bulk continuous polymeric yarn 300 having antimicrobial and/or antibacterial properties is illustrated in FIG. 2A. The method 400 may include, at 410, preparation of an herbal masterbatch, such as the herbal masterbatch as described above.

In one embodiment of the present disclosure, preparation of the herbal masterbatch may include certain steps, such as steps 412, 414 and 416, as shown in FIG. 2B. Preparation of the herbal masterbatch may, at 412, include mixing the herbal component having chemical extract of Neem or Turmeric or combination thereof, and the carrier polymer, for example, PBT, PET, polyamides, or polypropylene, in desired proportion as mentioned above. Further, at 414, the mixture of the herbal component and the carrier polymer are melted at a temperature in a range of 175° C. to 300° C.; preferably in a range of 200° C. to 275° C.; more preferably in a range of 220° C. to 275° C., to obtain a melted homogeneous mixture of the herbal component and the carrier polymer. Furthermore, at 416, the melted homogeneous mixture of the herbal component and the carrier polymer, may be solidified at a temperature in a range of 4° C. to 30° C. to obtain the herbal masterbatch. Subsequently, as per the requirement, the herbal masterbatch may go under granulation, which involves cutting the masterbatch into granules of the size in the range of 40 chips per gram to 200 chips per gram; preferably in the range of 60 chips per gram to 100 chips per gram; more preferably in the range of 70 chips per gram to 90 chips per gram.

Referring back to FIG. 2A, at 420, the base polymer, which includes one of PBT, PET, polyamides, polypropylene is prepared in the form of granules. Furthermore, at 430 the herbal masterbatch and the base polymer are mixed together in desired ranges such as described above. Moreover, at 440, the mixture of the herbal masterbatch and the base polymer are melted and extruded at a temperature in a range of 175° C. to 300° C.; preferably in a range of 200° C. to 290° C.; more preferably in a range of 220° C. to 280° C., to obtain the polymeric yarn having the herbal component in a range of 0.01% to 10%; preferably in the range of 1% to 8%; more preferably, greater than 1% to up to 6%, on weight of the polymeric yarn.

In one embodiment of the present disclosure, the polymeric yarn 100 may be formed by a single-step continuous process, on a single machine line, including the steps of: extruding, spinning, quenching, spin finish application, drawing, and/or texturing, cooling, intermingling and winding at the predetermined parameters. In such embodiment of the present disclosure, the mixture of the herbal masterbatch and the base polymer are melted and extruded at the gradual temperature having a range of 175° C. to 300° C. through a plurality of temperature zones, and at a pressure range of 60 bars to 130 bars. Further, the step of spinning is performed, followed by a gradual quenching, at the predetermined parameters, via, an air flow, having a quenching air flow temperature in a range of 10° C. to 25° C., quenching air flow rate in a range of 0.1 mt/sec to 0.4 mt/sec, and quenching air flow pressure in a range of 1 bars to 4 bars. After quenching, spin finish application is performed. Furthermore, after the spin finish application, the spin finish application yarn is sequentially drawn at predetermined parameters, such as drawing speed and drawing temperature. In one embodiment of the present disclosure, the drawing speed may be in a range of 760 mpm to 3500 mpm, and the drawing temperature range may be in a range of 80° C. to 190° C. Thereafter, the drawn yarn may be optionally textured at a texturing temperature range of 120° C. to 190° C. and a texturing vacuum pressure range of 50 mbars to 150 mbars. The drawn yarn may be cooled intermingled and wounded to obtain the polymeric yarn 100 having the herbal component in a range of 0.01% to 10%; preferably in a range of 1% to 8%; more preferably greater than 1% to up to 6%, on weight of the polymeric yarn.

Referring back to FIG. 2A, in one embodiment of the present disclosure, the method 400, at 430, may further include cabling or twisting the polymeric yarn in a range of 40 TPM (Twist Per Meter) to 350 TPM; preferably in a range of 120 TPM to 230 TPM; more preferably in a range of 180 TPM to 220 TPM to obtain the polymeric yarn with twists 200 (hereafter may also be referred to as “twisted polymeric yarn 200”), as shown in FIG. 1B. Such twisted polymeric yarn 200 may also include the herbal component in the range of 0.01% to 10%; preferably in the range of 1% to 8%; more preferably, greater than 1% to up to 6%, on weight of the polymeric yarn.

Furthermore, in one embodiment of the present disclosure, the method 400, at 440, may further include heat setting the twists of the polymeric yarn, such as the bulk continuous polymeric yarn 300. Heat treating may be carried out by a fluid, such as air, steam, or any other compressible liquid or vapor capable of transferring heat to the twisted yarn as it continuously travels through a heat setting device. The temperature of such fluid must be such that the yarn does not melt. If the temperature of the yarn is above the melting point of the yarn it is necessary to shorten the time in which the yarn dwells in the heat setting device. This step of heat setting utilizes such stream capable of transferring heat to the twisted yarn as it continuously travels through the heat setting device, at a temperature 100° C. to 200° C.; preferably 120° C. to 190° C.; more preferably 125° C. to 190° C. This process is affected by the length of time during which the twisted yarn is exposed to the heating medium (time/temperature effect). Generally, useful exposure times are from 30 seconds to 90 seconds; preferably from 40 seconds to 60 seconds.

In one another aspect of the present disclosure, a polymeric yarn, such as the yarns 100, 200 and 300 may be made by an herbal component (not necessarily the herbal masterbatch) having the chemical extract of Neem or Turmeric or combination thereof; and the base polymer having one of PBT, PET, polyamides, polypropylene, wherein the herbal component in the polymeric yarn is in a range of 0.01% to 10%; preferably in the range of 1% to 8%; more preferably, greater than 1% to up to 6%, on weight of the polymeric yarn.

In one embodiment of the present disclosure, the polymeric yarns, such as the yarns 100, 200 and 300 may exhibit a denier per filament (DPF) ratio measuring in a range of 0.5 DPF to 50 DPF; preferably in a range of 1 DPF to 40 DPF; more preferably in a range of 3 DPF to 20 DPF.

In one embodiment of the present disclosure, the one or more of the polymeric yarns, as described above, may be used to make various kind of textile materials, including but not limited to, floor covering textile materials, such as carpets, matts, rugs and so forth. The textile materials that made from the polymeric yarn may include, but not limited to, either one of knitted, tufted, or woven textile materials, such as floor covering textile materials.

As tested in the lab, the textile material made from such yarns shows tremendous improvement in killing or controlling the growth of bacteria or microorganism that may flourish on textile materials. More specifically, use of the herbal composition shows tremendous improvement in killing or controlling the growth of bacteria, particularly gram positive and gram negative bacteria, or microorganism, on the textile materials by about 90% to 99.99%, as shown by various lab test presented below:

| | | | | | | | | % Reduction in |
|---|---|---|---|---|---|---|---|---|
| | | | Herbal | | | | | gram positive |
| | | | component | | Base | | | and gram |
| | Test | Herbal | in | Herbal | Polymer | | | negative |
| | done | Masterbatch | Masterbatch | Component | in Yarn | | No of | bacteria and |
| Polymeric Yarn | on | % in Yarn | (%) | in yarn (%) | (%) | Denier | Filament | microorganisms |
| Herbal | Yarn | 1.00% | 20.00% | 0.20% | 99.80% | 1288 | 66 | fabric doesn't |
| Masterbatch | | | | | | | | show any |
| (Neem) + Base | | | | | | | | antibacterial |
| polymer (PA6) | | | | | | | | activity |
| Herbal | Yarn | 2.00% | 20.00% | 0.40% | 99.60% | 1288 | 66 | 98% |
| Masterbatch | | | | | | | | |
| (Neem) + Base | | | | | | | | |
| polymer (PA6) | | | | | | | | |
| Herbal | Yarn | 3.00% | 20.00% | 0.60% | 99.40% | 1288 | 66 | 97% |
| Masterbatch | | | | | | | | |
| (Neem) + Base | | | | | | | | |
| polymer (PA6) | | | | | | | | |
| Herbal | Yarn | 4.00% | 20.00% | 0.80% | 99.20% | 1288 | 66 | 97% |
| Masterbatch | | | | | | | | |
| (Neem) + Base | | | | | | | | |
| polymer (PA6) | | | | | | | | |
| Herbal | Yarn | 4.00% | 20.00% | 0.80% | 99.20% | 1288 | 66 | 98% |
| Masterbatch | | | | | | | | |
| (Neem) + Base | | | | | | | | |
| polymer (PA6) | | | | | | | | |
| Herbal | Yarn | 4.00% | 20.00% | 0.80% | 99.20% | 1200 | 120 | 97% |
| Masterbatch | | | | | | | | |
| (Neem) + Base | | | | | | | | |
| polymer (PBT) | | | | | | | | |
| Herbal | Yarn | 4.00% | 20.00% | 0.80% | 99.20% | 1200 | 120 | 96% |
| Masterbatch | | | | | | | | |
| (Neem) + Base | | | | | | | | |
| polymer (PBT) | | | | | | | | |
| Herbal | Yarn | 5.50% | 20.00% | 1.10% | 98.90% | 1200 | 120 | 97% |
| Masterbatch | | | | | | | | |
| (Neem) + Base | | | | | | | | |
| polymer (PBT) | | | | | | | | |
| Herbal | BCF | 2.00% | 20.00% | 0.40% | 99.60% | 1288 | 68 | 94% |
| Masterbatch | Tuft | | | | | | | |
| (Neem) + Base | | | | | | | | |
| polymer (PA6) | | | | | | | | |
| Herbal | BCF | 3.00% | 20.00% | 0.60% | 99.40% | 1288 | 68 | 96% |
| Masterbatch | Tuft | | | | | | | |
| (Neem) + Base | | | | | | | | |
| polymer (PA6) | | | | | | | | |
| Herbal | BCF | 4.00% | 20.00% | 0.80% | 99.20% | 1288 | 68 | 96% |
| Masterbatch | Tuft | | | | | | | |
| (Neem) + Base | | | | | | | | |
| polymer (PA6) | | | | | | | | |
| Herbal | BCF | 2.00% | 6.00% | 0.12% | 99.88% | 1200 | 68 | 90% |
| Masterbatch | Tuft | | | | | | | |
| (Turmeric) + Base | | | | | | | | |
| polymer (PA6) | | | | | | | | |
| Herbal | BCF | 3.00% | 6.00% | 0.18% | 99.82% | 1200 | 68 | 88% |
| Masterbatch | Tuft | | | | | | | |
| (Turmeric) + Base | | | | | | | | |
| polymer (PA6) | | | | | | | | |
| Herbal | BCF | 4.00% | 6.00% | 0.24% | 99.76% | 1200 | 68 | 93% |
| Masterbatch | Tuft | | | | | | | |
| (Turmeric) + Base | | | | | | | | |
| polymer (PA6) | | | | | | | | |
| Herbal | BCF | 2.00% | 14.00% | 0.28% | 99.72% | 1200 | 68 | 95% |
| Masterbatch | Tuft | | | | | | | |
| (Neem + | | | | | | | | |
| Turmeric) + Base | | | | | | | | |
| polymer (PA6) | | | | | | | | |
| Herbal | BCF | 3.00% | 14.00% | 0.42% | 99.58% | 1200 | 68 | 94% |
| Masterbatch | Tuft | | | | | | | |
| (Neem + | | | | | | | | |
| Turmeric) + Base | | | | | | | | |
| polymer (PA6) | | | | | | | | |
| Herbal | BCF | 4.00% | 14.00% | 0.56% | 99.44% | 1200 | 68 | 94% |
| Masterbatch | Tuft | | | | | | | |
| (Neem + | | | | | | | | |
| Turmeric) + Base | | | | | | | | |
| polymer (PA6) | | | | | | | | |
| Herbal | BCF | 2.00% | 20.00% | 0.40% | 99.60% | 1200 | 120 | 90% |
| Masterbatch | Tuft | | | | | | | |
| (Neem) + Base | | | | | | | | |
| polymer (PBT) | | | | | | | | |
| Herbal | BCF | 3.00% | 20.00% | 0.60% | 99.40% | 1200 | 120 | 95% |
| Masterbatch | Tuft | | | | | | | |
| (Neem) + Base | | | | | | | | |
| polymer (PBT) | | | | | | | | |
| Herbal | BCF | 4.00% | 20.00% | 0.80% | 99.20% | 1200 | 120 | 96% |
| Masterbatch | Tuft | | | | | | | |
| (Neem) + Base | | | | | | | | |
| polymer (PBT) | | | | | | | | |
| Herbal | Heat | 2.00% | 20.00% | 0.40% | 99.60% | 1200 | 120 | 97% |
| Masterbatch | set | | | | | | | |
| (Neem) + Base | tuft | | | | | | | |
| polymer (PBT) | | | | | | | | |
| Herbal | Heat | 3.00% | 20.00% | 0.60% | 99.40% | 1200 | 120 | 91% |
| Masterbatch | set | | | | | | | |
| (Neem) + Base | tuft | | | | | | | |
| polymer (PBT) | | | | | | | | |
| Herbal | Heat | 4.00% | 20.00% | 0.80% | 99.20% | 1200 | 120 | 93% |
| Masterbatch | set | | | | | | | |
| (Neem) + Base | tuft | | | | | | | |
| polymer (PBT) | | | | | | | | |

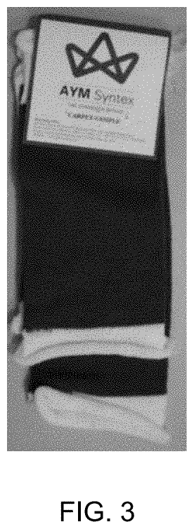

One of a test results for sample as shown in FIG. 3 is depicted for reference below:

As presented, the present disclosure is advantageous in providing such composition, yarn or textile material that may control the growth or kills bacteria or microorganism that may flourish on textile materials. More specifically, the present disclosure is advantageous in providing such textile material that may control the growth or kills bacteria or microorganism via the herbal means that may flourish on textile materials. Furthermore, the present disclosure is advantageous in providing a method of preparing such textile material that may control the growth or kills bacteria or microorganism via the herbal means that may flourish on textile materials.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

We claim:

1. A polymeric yarn composition having antimicrobial and/or antibacterial properties for textile materials, the polymeric yarn composition comprising:
(i) an herbal masterbatch in a range of 0.01% w/w to 10% w/w, the herbal masterbatch comprising:
(a) an herbal component having Neem or Turmeric or combination thereof in a range of 1% w/w to 75% w/w, and
(b) a carrier polymer having at least one of: polybutylene terephthalate (PBT), polyethylene terephthalate (PET), or polyamides, polypropylene, wherein the carrier polymer is in a range of 25% w/w to 99% w/w; and
(ii) a base polymer having one of polybutylene terephthalate (PBT) or polyethylene terephthalate (PET), or polyamides, or polypropylene in a range of 90% w/w to 99.99% w/w,
wherein the herbal masterbatch and the base polymer are melted and extruded together at a temperature in a range of 175° C. to 300° C. to obtain a polymeric yarn having the herbal component in a range of 0.01% to 10% in weight of the polymeric yarn.

2. The polymeric yarn composition of claim 1, wherein the polymeric yarn is configured to reduce gram positive and gram negative bacteria and microorganisms by about 85% to 99.99%.

3. The polymeric yarn composition of claim 1, wherein the textile materials made from the polymeric yarn includes floor covering materials.

4. The polymeric yarn composition of claim 1, wherein the textile materials made from the polymeric yarn comprise either one of knitted, tufted, or woven textile materials.

5. The polymeric yarn composition of claim 1, wherein the Neem or Turmeric or combination thereof is used in a powder form.

6. The polymeric yarn composition of claim 5, wherein size of the powder is in a range of 0.001 microns to 25 microns.

7. The polymeric yarn composition of claim 1, wherein the Neem or Turmeric or combination thereof is used in a liquid form.

8. The polymeric yarn composition of claim 1, wherein the polyamides comprise PA6 or PA66.

9. The polymeric yarn composition of claim 1, wherein the polymeric yarn exhibits a denier per filament (DPF) ratio measuring in a range of 0.5 DPF to 50 DPF.

10. The polymeric yarn composition of claim 1, wherein the polymeric yarn is cabled with at least 1 ply between 40 TPM (Twist Per Meter) to 350 TPM to obtain a polymeric yarn with twists.

11. The polymeric yarn composition of claim 10, wherein the polymeric yarn with twists is heat set.

12. A method for preparing a polymeric yarn having antimicrobial and/or antibacterial properties for textile materials, the method comprising:
preparing an herbal masterbatch, wherein the herbal masterbatch comprises: an herbal component having Neem or Turmeric or combination thereof in a range of 1% w/w to 75% w/w, and a carrier polymer having at least one of polybutylene terephthalate (PBT), or poly(ethylene terephthalate) (PET), polyamides, or polypropylene, wherein the carrier polymer is in a range of 25% w/w to 99% w/w;
mixing the herbal masterbatch in a range of 0.01% w/w to 10% w/w, and a base polymer in a range of 90% w/w to 99.99% w/w, wherein the base polymer comprises one of polybutylene terephthalate (PBT) or polyethylene terephthalate (PET), or polyamides, or polypropylene; and
melting and extruding the mixture of the herbal masterbatch and the base polymer at a temperature in a range of 175° C. to 300° C. to obtain the polymeric yarn having the herbal component in a range of 0.01% to 10% on weight of the polymeric yarn.

13. The method of claim 12, wherein preparing the herbal masterbatch comprises:
melting a mixture of the herbal component and the carrier polymer at a temperature in a range of 175° C. to 300° C. to obtain a melted homogeneous mixture of the herbal component and the carrier polymer, wherein the mixture of the herbal component and the carrier polymer comprises: Neem or Turmeric or combination thereof in the range of 1% w/w to 75% w/w, and the carrier polymer having at least one of the polybutylene terephthalate (PBT), or the poly(ethylene terephthalate) (PET), or the polyamides, or polypropylene, wherein the carrier polymer is in the range of 25% w/w to 99% w/w; and
solidifying the melted homogeneous mixture herbal component and the carrier polymer underwater at a temperature in a range of 4° C. to 30° C. to obtain the herbal masterbatch.

14. The method of claim 13 further comprising cabling the polymeric yarn in a range of 40 TPM (Twist Per Meter) to 350 TPM to obtain the polymeric yarn with twists.

15. The method of claim 14 further comprising heat setting the twists of the polymeric yarn.

16. An herbal masterbatch composition for making a polymeric yarn for textile materials, the herbal masterbatch composition comprising:
an herbal component having Neem or Turmeric or combination thereof in a range of 1% w/w to 75% w/w; and
a carrier polymer having at least one of:
polybutylene terephthalate (PBT),
polyethylene terephthalate (PET), or
polyamides, or
polypropylene,
wherein the carrier polymer is in a range of 25% w/w to 99% w/w.

17. The herbal masterbatch composition of claim 16, wherein the herbal composition having the Neem or Turmeric or combination thereof in a powder form.

18. The herbal masterbatch composition of claim 17, wherein size of the powder is in a range of 0.001 microns to 25 microns.

19. The herbal masterbatch composition of claim 16, wherein the herbal composition having the Neem or Turmeric or combination thereof in a liquid form.

20. A polymeric yarn for textile materials comprising:
an herbal component having Neem or Turmeric or combination thereof; and
a base polymer having one of polybutylene terephthalate (PBT) or polyethylene terephthalate (PET), or polyamides, or polypropylene,
wherein the herbal component in the polymeric yarn is in a range of 0.01% to 10% on the weight of the polymeric yarn.
